(19) United States
(12) Patent Application Publication
(10) Pub. No.: US 2019/0321753 A1
(43) Pub. Date: Oct. 24, 2019

(54) NEW DEVICE FOR GAS-LIQUID SEPARATION, INTENDED FOR THREE-PHASE FLUIDISED BED REACTORS SUCH AS THOSE USED IN THE H-OIL PROCESS

(71) Applicant: IFP Energies nouvelles, Rueil-Malmaison (FR)

(72) Inventors: Benjamin AMBLARD, Lyon (FR); Daniel FERRE, Saint Cyr sur Rhone (FR); Jean-Francois LE COZ, Saint Germain en Laye (FR)

(73) Assignee: IFP Energies nouvelles, Rueil-Malmaison (FR)

(21) Appl. No.: 16/348,745

(22) PCT Filed: Oct. 31, 2017
(86) PCT No.: PCT/EP2017/077848

§ 371 Date: May 9, 2019

(30) Foreign Application Priority Data
Nov. 9, 2016 (FR) 1660835

(51) Int. Cl. B01D 17/00; B01D 19/00; B01J 8/22; C10G 49/22

(52) U.S. Cl. CPC B01D 17/00; C10G 49/22; B01J 8/22; B01D 19/0052

(57) ABSTRACT

The present invention describes a device for gas-liquid separation, intended for three-phase fluidized bed reactors such as those used in the H-oil process. The present device exhibits an optimized helicoidal spiral.

### CONTEXT OF THE INVENTION

The invention forms part of improvements to the sizing of the upper part of gas-liquid solid reactors used in the H-oil process in order to obtain better gas/liquid separation in said upper zone often referred to as the “recycle cup”. The term “recycle cup” is the specialist term used for what in this document will be referred to as the liquid recycling zone or, more simply, the recycle zone. The term “spiral riser” is the term often used for what in this document will be referred to as the gas/liquid separation device.

The H-oil process is a process for the hydroconversion of heavy hydrocarbon fractions, of the residue or vacuum gas oil type, which therefore brings together the liquid hydrocarbon phase, the hydrogen gas phase dispersed in the form of bubbles, and the catalyst itself dispersed in the form of particles with a particle size typically comprised between 0.2 and 2 millimeters. The H-oil process is therefore a three-phase fluidized process which uses a special-purpose reactor, said reactor being equipped with a gas-liquid separation device situated in the upper part of the reactor so as to allow recycling of the liquid which is returned after separation in the reaction zone of the reactor.

One of the significant features of reactors of the H-oil type is their liquid recycle rate defined as being the ratio of the flow rate of recycled liquid to the flow rate of incoming liquid feedstock, and which generally lies in the range 1 to 10.

The present invention can be defined as being an improved gas-liquid separation device for reactors of the H-oil type that allows the majority of the liquid to be reintroduced without gas into the reaction zone, with the gas (which may still contain a minority of liquid) being removed out of the reactor.

The present device makes it possible to achieve gas/liquid separation efficiencies that are higher than that of the “spiral risers” of the prior art.

### BRIEF DESCRIPTION OF THE FIGURES

FIG. 1 according to the prior art depicts a diagram of a three-phase fluidized bed reactor used in the H-oil process. This figure shows the reaction zone (22) corresponding to the three-phase fluidized bed containing the catalyst, the zone situated above the catalytic zone and referred to as the gas-liquid separation zone (29) which allows liquid to be recycled to the lower part of the reactor by means of the recirculation pump (20). Finally, the gas solid separation devices are indicated by the elements (27) and (28), some elements having their lower end situated in the zone (29), while other elements have their lower end situated on the conical surface of the “recycle cup” (39). It is these separation elements that form the subject of the present invention, the rest of the reactor remaining unchanged in comparison with the prior art.

FIG. 2 is a more detailed schematic view of the upper part of the reactor referred to as the liquid recycling zone because it ends in an internal pipe (25) which, after gas/liquid separation, returns the liquid to the lower part of the reactor via the recirculation pump (20). The gas-liquid separation devices are installed along the conical surface (30) of the recycle zone. The gas/liquid mixture is admitted via the pipes (75). Gas/liquid separation takes place in the devices (42). Each separation device (42) is capped by an upper cap (50) comprising an upper end (55) for the removal of the gas, and a lower pipe (70) creating an annular space around the inlet pipe (75).

The liquid is recovered by the outlet pipes extending downward in the direction of the arrow (45), and the gas is removed via the upper pipe (55). The gas leaves the reactor via the outlet pipe in the direction of the arrow (67).

FIG. 3 bears information allowing the dimensioning of the separation devices (27) and (28) according to the invention. The angles alpha and beta, and the angle gamma that the helicoidal spiral (42) makes with the horizontal will be noted in particular.

FIG. 4 is a visual depiction of the gas-liquid separation efficiency, resulting from a 3D simulation performed using the Fluent™ software package.

### EXAMINATION OF THE PRIOR ART

An examination of the prior art in the field of gas-liquid separation in three-phase fluidized reactors of the H-oil type reveals document U.S. Pat. No. 4,886,644, which is briefly analyzed below: U.S. Pat. No. 4,886,644, which can be considered to be the closest prior art, describes the concept of “spiral risers” in the H-oil process. The main claims relate to the design of the “spiral risers” (the number of turns of the spiral and the angle with respect to the horizontal).

The “recycle cup” described in the cited text corresponds to the upper part of the reactor which, after separation of the gas and of the liquid, allows the liquid to return to the reaction zone of the reactor and the gas to be removed by a dedicated pipe. In the remainder of the text the expression upper liquid recycle zone or, more simply, recycle zone, will be used to refer to the “recycle cup”.

Document U.S. Pat. No. 4,886,644 also discloses an arrangement of the upper recycle zone which combines the gas/liquid removal pipe at the top of the reactor with a hydrocyclone.

### BRIEF DESCRIPTION OF THE INVENTION

The present invention may be defined as being a gas-liquid separation device installed in the recycle zone of the three-phase fluidized reactors used in processes for the hydroconversion of heavy hydrocarbon fractions in the presence of hydrogen under high pressure, which process we shall refer to as a process of the H-oil type. In fact, the present device can be used in any type of three-phase fluidized bed reactor that has need of gas-liquid separation.

What is to be understood by the expression three-phase fluidized bed process is a process in which three phases are present in the reaction zone: a liquid phase, generally constituting the feedstock that is to be processed; a gas phase under high pressure, generally hydrogen; and a solid phase corresponding to the catalyst divided into solid particles, usually of a diameter comprised between 0.2 and 2 mm, and preferably comprised between 0.7 and 1.5 mm. These indications regarding the diameter of the particles do not impose any limit on the present invention because this invention relates to the separation of the gas and of the liquid, the solid phase being situated upstream of the gas-liquid separation zone.

The separation device according to the present invention consists in a plurality of separation elements (27) and (28) operating in parallel and installed vertically from the conical surface (30) of the recycle zone (39). The recycle zone (39) can be broken down into an upper part (39 v) corresponding to the gas, and into a lower part (39 I) corresponding to the liquid. During operation, these two zones are separated by a gas-liquid interface (24).

Each separation element (27) and (28) is equipped with a helicoidal spiral (42) situated in the upper part of the inlet pipe (75) leading the gas-liquid mixture coming from the zone (29) into each of said separation elements (27) and (28).

Each separation element (27) and (28) is capped by an upper cap (50) which at its upper end comprises a gas removal pipe (53), and at its lower end comprises a vertical pipe (70) substantially concentric with the inlet pipe (75) and allowing the separated liquid to be returned to the reaction zone via the overall return pipe (25).

Each separation element (27) and (28) is therefore made up of the inlet pipe (75), of the upper cap (50), of the liquid return pipe (70), and of a conical transition zone (47) connecting the upper cap (50) to the liquid return pipe (70).

The upper part of each separation element (27) and (28) is situated above the gas-liquid interface (24). This gas-liquid interface (24) establishes itself during operation substantially at the level of the slots (65) with which the lower part of the gas removal pipe (40) is equipped.

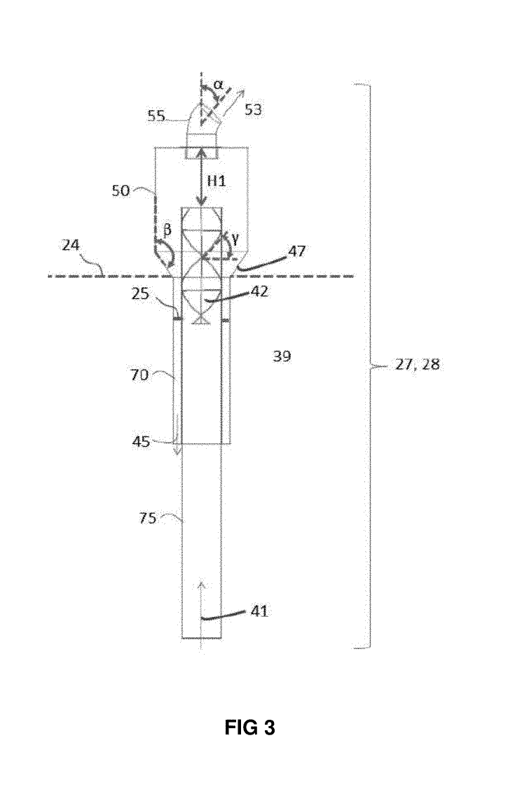

The annular zone comprised between the inlet pipe (75) and the vertical liquid return pipe (70) contains the recycled liquid as far as a certain level marked (25) in FIG. 3. This liquid level (25) needs to remain distinct from the gas-liquid interface (24).

The diameter of the inlet pipe (75) is generally comprised between 0.02 m and 0.5 m, preferably comprised between 0.05 m and 0.4 m, and more preferably still, comprised between 0.1 m and 0.3 m.

The gas-liquid separation device according to the present invention contains, inside each separation element (27) and (28), a helicoidal spiral (42) that forms an angle γ with the horizontal comprised between 10° and 80°, preferably between 20° and 70°, and for preference, between 35° and 60°.

The helicoidal spiral (42) contained in each separation element (27) and (28) makes a number of rotations comprised between 0.5 and 4, each rotation corresponding to 1 full turn (360°), preferably between 0.5 and 2 turns when passing from the lower part to the upper part of each separation element.

The ratio of the diameter of the upper cap (50) which caps the inlet pipe (75) in its upper part, to the diameter of said inlet pipe (75) is generally comprised between 1 and 6, preferably between 1.5 and 5, and for preference, between 2 and 4.

The ratio of the diameter of the gas removal pipe (55) situated at the upper end of the separation elements (27) and (28) to the diameter of said separation element (75) is generally comprised between 0.3 and 5, preferably between 0.5 and 4, and for preference, between 0.6 and 3.

The height H1 defined as being the distance separating the upper end of the spirals (42) from the gas outlet (55) of the separation elements (27) and (28), considered at its lower end, exhibits a ratio H1/diameter of the separation elements (27) and (28) comprised between 0.5 and 6, preferably between 0.7 and 5, and for preference, between 1 and 4.

The angle α of the gas outlet pipe (55) with respect to the vertical is generally comprised between 0° and 135°, preferably between 10° and 120°, and for preference, between 30° and 90°.

The ratio of the diameter of the lower pipe (70) returning the liquid after separation toward the recirculation pipe (31), to the diameter of the inlet pipe (75), is generally comprised between 1 and 5, preferably between 1.1 and 4, and more preferably still, comprised between 1.5 and 3.

The length of the liquid return pipe (70) needs to be greater than the distance separating the interfaces (24) and (25) so as to create a “plug” of liquid in said pipe (70), the purpose of this being to prevent the gas from dropping down toward the liquid zone 39L.

Finally, the conical part (47) which connects the upper cap (50) to the lower part (70), which caps the separation elements (27) and (28), makes an angle β with respect to the vertical generally comprised between 90° and 270°, preferably between 100° and 200°, and for preference, between 120° and 150°.

The gas-liquid separation device according to the invention generally has a density of separation elements (27) and (28) comprised between 5 and 70 units per m² of empty barrel reactor surface area.

The present invention may also be defined as being a process for the three-phase fluidized bed hydroconversion of heavy hydrocarbon fractions using the gas-liquid separation device according to the characteristics given above, said process operating under the following operating conditions:
an absolute pressure comprised between 2 and 35 MPa, preferably between 5 and 25 MPa, and more preferably still, between 6 and 20 MPa, and
a temperature comprised between 300° C. and 550° C., preferably comprised between 350 and 500° C., and more preferably still, comprised between 370 and 460° C., the favored temperature range lying between 380° C. and 440° C.
the surface velocity of the upflow considered inside each inlet pipe (75) is generally comprised between 0.1 and 20 m/s, preferably between 0.2 and 15 m/s, and more preferably still, comprised between 0.3 and 10 m/s.

### DETAILED DESCRIPTION OF THE INVENTION

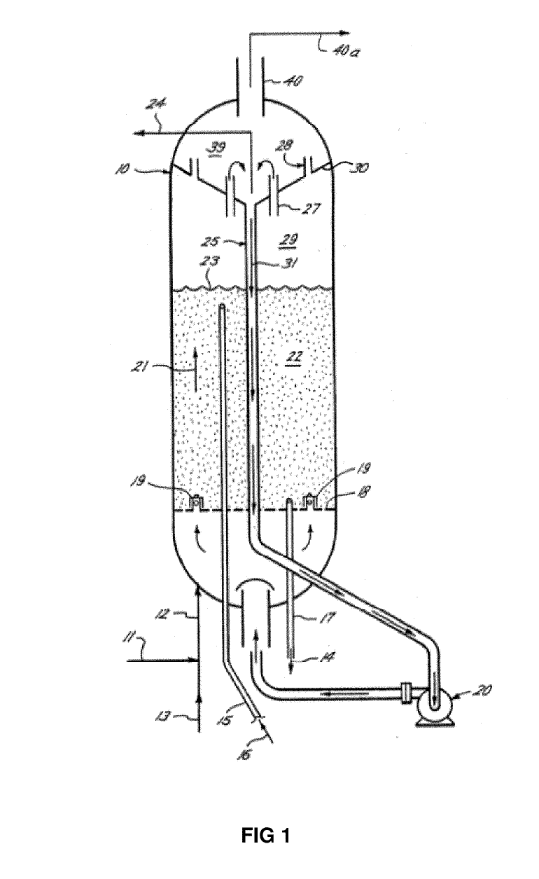

For a full understanding of the invention it is necessary to briefly describe the operation of a reactor of the H-oil type, as depicted in FIG. 1 according to the prior art.

FIG. 1 is an indicative diagram showing the key elements of an H-oil reactor according to the prior art. This reactor is specially designed with suitable materials that allow it to process reactive liquids, liquid—solid slurries (which is to say liquids containing fine particles of solid dispersed within them), solids and gases at high temperatures and pressures with a preferred application to the treatment of liquid hydrocarbon fractions with hydrogen at a high temperature and high pressure, which means to say at an absolute pressure comprised between 2 and 35 MPa, preferably between 5 and 25 MPa, and more preferably still, between 6 and 20 MPa, and at a temperature comprised between 300° C. and 550° C., preferably comprised between 350° C. and 500° C., and, more preferably still, comprised between 370° C. and 460° C., the favored temperature range lying between 380° C. and 440° C.

the H-oil type reactor (10) is designed with a suitable inlet pipe (12) for injecting a heavy hydrocarbon feedstock (11) and a gas (13) containing hydrogen. The outlet pipes are positioned in the upper part of the reactor (10). The outlet pipe (40) is designed to draw off vapors which may contain a certain quantity of liquid, and, as an option, the pipe (24) allows chiefly liquid to be drawn off.

The reactor also contains a system allowing particles of catalyst to be introduced and withdrawn, this system being indicated schematically by the pipe (15) for introducing fresh catalyst (16), and the pipe (17) for drawing off the spent catalyst (14).

The heavy hydrocarbon feedstock is introduced through the pipe (11), while the gas containing hydrogen is introduced through the pipe (13). The feedstock and gaseous hydrogen mixture is then introduced into the reactor (10) through the pipe (12) into the lower part of the reactor.

The incoming fluids pass through a plate (18) containing suitable distributors. In this diagram, distributors of the “bubble cap” type (19) are shown, but it must be appreciated that any distributor known to those skilled in the art that allows the fluids coming from the pipe (12) to be distributed over the entire surface of the reactor (10), and do so as evenly as possible, can be used.

The liquid/gas mixture flows upward and the particles of catalyst are entrained in a bubbling bed movement by the flow of gas and flow of liquid induced by the recirculation pump (20) which may be internal or external to the reactor (10).

The upflow of liquid delivered by the pump (20) is enough for the mass of catalyst in the reaction zone or catalytic bed (22) to expand by at least 10%, preferably from 20 to 100% with respect to the static volume (which means to say the volume it has at rest) of the catalyst bed, thus allowing the gas and liquid to flow through the reactor (10) as indicated by the direction arrows (21).

Because of the equilibrium between the friction forces generated by the upflow of the liquid and of the gas, and the forces of gravity directed downward, the bed of catalyst particles reaches an upper level of expansion while the liquid and the gas, which are lighter, continue to head toward the top of the reactor (10), beyond this solid level. In the diagram, the level of maximum expansion of the catalyst corresponds to the interface (23). Below this interface (23) is the catalytic reaction zone (22) which therefore extends from the grating (18) to the level (23).

Above the interface (23) is a zone (39) containing only gas and liquid. The particles of catalyst in the reaction zone (22) move randomly in a fluidized state, which is why the reaction zone (22) is qualified as a three-phase fluidized zone.

The zone (29) containing a low concentration of catalyst above the level (23) is filled with liquid and entrained gas. The gas is separated from the liquid in the upper part of the reactor referred to as the “recycle cup” (30) so as to collect and recycle the majority of the liquid through the central pipe (25). It is important for the liquid recycled through the central pipe (25) to contain the least possible amount of gas, or even no gas at all, so as to avoid the phenomenon of cavitation in the pump (20).

The liquid products that remain after the gas-liquid separation can be drawn off through the pipe (24). The pipe (40) is used for drawing off the gas.

The widened part at the upper end of the pipe (25) forms the liquid recycle zone 39V and 39L. A plurality of separation elements (27) and (28) directed vertically creates the connection between the gas-liquid zone (29) and the recycle zone (39). The gas-liquid mixture flows upward through the pipes of the separation elements (27) and (28). Some of the separated liquid is then directed toward the recirculation pump (20) in the direction of the arrow (31) through the central pipe (25) and is therefore recycled to the lower part of the reactor (10) below the grating (18). The gas separated from the liquid flows toward the upper part of the reactor (10) and is drawn off by the upper pipe (40). The gas drawn off is then treated in a conventional way to recover as much hydrogen as possible so that the latter is recycled to the reactor through the pipe (13). The overall organization of the circulation of the fluids is unchanged in the present invention in comparison with the prior art such as has just been described. The only things modified are the geometry of the separation elements (27) and (28) and the dimensioning of the recycle zone (39).

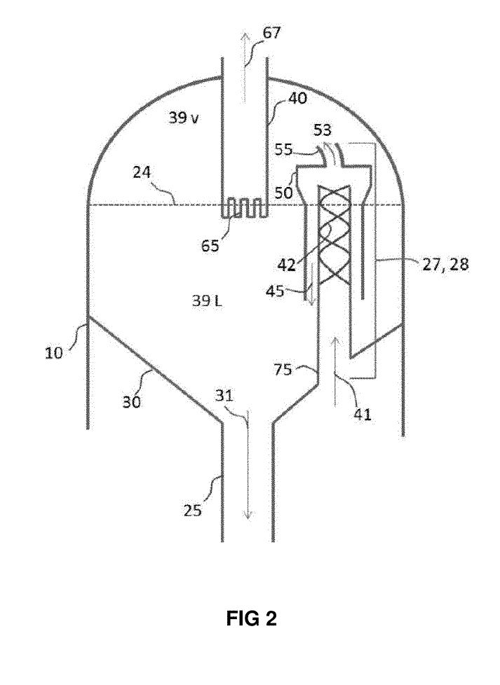

FIG. 2 is a more accurate diagram of the recycle zone (39) depicted in FIG. 1. The gas and the liquid flow upward as indicated by the direction arrow (41) and are introduced via the inlet pipes (75) where they come into contact with a helicoidal spiral (42) contained inside each of the pipes (75) which imparts a tangential velocity to the two fluids. The helicoidal spiral (42) brings about a centrifugal separation where the liquid, which has a higher density than the gas, is pressed against the internal wall of the cap (50) whereas the gas (53) is directed through the pipe (55) toward a gas phase zone (39 v) delimited by the liquid level (24).

In fact, the level (24) separates the upper part (39 V) which predominantly contains the separated gas, from the lower part (39L) which predominantly contains the recycled liquid. The various separated liquids (45) emanating from the various separation elements (27) and (28) flow downward via the conical wall (30) and are collected by the central recycle pipe (25) to be picked up by the recirculation pump (20).

The majority of the liquid (31) is therefore recycled to the ebullition pump (20) through the central pipe (25). The gas and a minority of unseparated liquid are drawn off through the pipe (40) in the direction of the arrow (67). The pipe (40) generally has slots (65) at its lower end to make it possible to fix the height of the liquid-gas interface (24).

FIG. 3 shows the design of a gas-liquid separation device according to the invention in greater detail and shows the key geometric dimensions for dimensioning said device. The diameter of the inlet pipe (75) of each separation element (27) and (28) is generally comprised between 0.02 m and 0.5 m, preferably between 0.05 m and 0.4 m, and as a preference, between 0.1 m and 0.3 m.

The surface velocity of the upflow liquid indicated by the direction arrow (41) is generally comprised between 0.1 and 20 m/s, preferably between 0.2 and 15 m/s, and for preference, between 0.3 and 10 m/s.

The helicoidal spiral (42) forms an angle γ with the horizontal comprised between 10° and 80°, preferably between 20° and 70°, and for preference, between 35° and 60°. The spiral makes a number of rotations comprised between 0.5 and 4 full turns (a full turn being equal to a rotation through 360°) preferably between 0.5 and 2 full turns when passing from its lower end to its upper end.

The ratio of the diameter of the upper cap (50), to the diameter of the inlet pipe (75) is generally comprised between 1 and 6, preferably between 1.5 and 5, and for preference, between 2 and 4.

The ratio of the diameter of the gas removal pipe (55) to the diameter of the inlet pipe (75) is generally comprised between 0.3 and 5, preferably between 0.5 and 4, and for preference, between 0.6 and 3.

The height H1 is defined as being the distance separating the upper end of the helicoidal spirals (42) from the lower end of the gas removal pipes (55). The ratio of the length H1, to the diameter of the inlet pipe (75) is generally comprised between 0.5 and 6, preferably between 0.7 and 5, and for preference, between 1 and 4.

The angle α of the gas outlet pipe (55) with respect to the vertical is generally comprised between 0° and 135°, preferably between 10° and 120°, and for preference, between 30° and 90°.

The ratio of the diameter of the lower pipe (70) surrounding the inlet pipe (75) to the diameter of said inlet pipe (75) is generally comprised between 1 and 5, preferably between 1.1 and 4, and for preference, between 1.5 and 3.

Finally, the conical transition (47) which connects the upper cap (50) to the lower part (70) of the separation elements (27) and (28) makes an angle β with respect to the vertical generally comprised between 90° and 270°, preferably between 100° and 200°, and for preference, between 120° and 150°.

### EXAMPLES ACCORDING TO THE INVENTION

This example gives the dimensions of a gas-liquid separation device according to the invention. The operating conditions for the process are given in table 1.

TABLE 1
Operating conditions of the recycle zone and geometric parameters of the
separator
Flow rates of the gas and liquid phases entering the recycle zone
Liquid

| | | |
|---|---|---|
| Flow rate | kg/s | 257.5 |
| Density | kg/m³ | 730.3 |

Gas

| | | |
|---|---|---|
| Flow rate | kg/s | 12.9 |
| Density | kg/m³ | 32.6 |

| | |
|---|---|
| Number of separation devices | 35 |
| according to the invention | |
| Diameter of each pipe (75) | 15 cm |
| Inclination of the spiral with respect | 50° |
| to the horizontal | |
| Number of turns of the spiral over its | 1 |
| rise | |

The gas and liquid separation efficiencies are defined by equations 1 and 2 below.

The flow numbers refer to FIG. 3.

$$\begin{matrix}Gas\_Efficiency ( \% m ) = \frac{Gas\_Flow \_Rate ( 53 )}{Gas\_Flow \_Rate ( 41 )} & Eq . 1 \\ Liquid\_Efficiency ( \% m ) = \frac{Liquid\_Flow \_Rate ( 45 )}{Liquid\_Flow \_Rate ( 41 )} & Eq . 2\end{matrix}$$

Table 2 below gives the gas and liquid efficiencies obtained:

TABLE 2
Separation efficiency

| | |
|---|---|
| Gas efficiency | 100% |
| Liquid efficiency | 99% |

A 3D CFD simulation of the invention was performed using the Fluent™ software package.

A Eulerian approach was used for each phase (liquid and gas), with a solution of equations of conservation of mass and momentum.

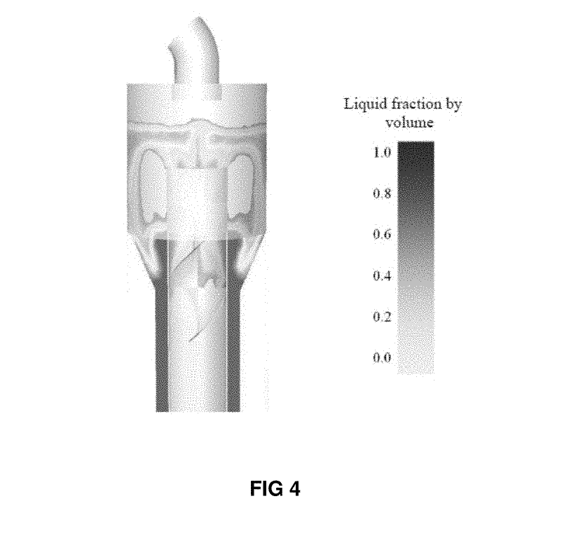

FIG. 4 shows the liquid fraction by volume in the separation device according to the invention in varying shades of gray. The darker the shade of gray, the higher the liquid phase concentration. It may be seen that the device according to the invention achieves near-perfect separation of the gas and of the liquid found along the wall (50) in downflow. The gas fraction finds itself in the outlet nozzle (53).

1. A gas-liquid separation device installed in the recycle zone of the three-phase fluidized reactors used in processes for the hydroconversion of heavy hydrocarbon fractions in the presence of hydrogen under high pressure, the recycle zone (39) being made up of the upper hemisphere of the reactor and delimited in its lower part by a conical surface (30) allowing the separated liquid to return to the catalytic zone, the device consisting in a plurality of separation elements (27) and (28) operating in parallel and installed vertically from the conical surface (30) of the recycle zone (39), each separation element (27) and (28) having an inlet pipe (75) for admitting the gas-liquid mixture, open onto the conical surface (30) and rising to a height H inside the separation zone (39), and being capped by an upper cap (50) equipped with a gas removal pipe (53) situated in the upper part of said cap, and with a tubular element (70) substantially coaxial with the element (75) and allowing the return of liquid, each element (27) and (28) being equipped with a helicoidal spiral (42) situated inside the inlet pipe (75) in the upper part of said elements (27) and (28), said helicoidal spiral (42) making an angle γ with the horizontal comprised between 10° and 80°, preferably between 20° and 70°, and for preference, between 35° and 60°, said helocoidal spiral (42) making, over its overall height, a number of rotations comprised between 0.5 and 4, each rotation corresponding to 1 full 360° turn, and preferably between 0.5 and 2 full 360° turns, in which gas-liquid separation device the ratio of the diameter of the upper cap (50) which caps the inlet pipe (75) in its upper part, to the diameter of said inlet pipe (75) is comprised between 1 and 6, preferably between 1.5 and 5, and for preference, between 2 and 4, and in which the ratio of the diameter of the gas removal pipe (55) situated at the upper end of the separation elements (27) and (28) to the diameter of the inlet pipe (75) is comprised between 0.3 and 5, preferably between 0.5 and 4, and for preference, between 0.6 and 3.

2. The gas-liquid separation device as claimed in claim 1, in which the height H1 defined as being the distance separating the outlet of the spirals (42), considered at their upper end, from the gas outlet (55) of the separation elements (27) and (28), considered at its lower end, exhibits a ratio H1/diameter of the inlet pipe (75) comprised between 0.5 and 6, preferably between 0.7 and 5, and for preference, between 1 and 4.

3. The gas-liquid separation device as claimed in claim 1, in which the angle α of the gas outlet pipe (55) with respect to the vertical is comprised between 0° and 135°, preferably between 10° and 120°, and for preference, between 30° and 90°.

4. The gas-solid separation device as claimed in claim 1, in which the ratio of the diameter of the lower pipe (70) returning the liquid after separation toward the recirculation pipe (31), to the diameter of the inlet pipe (75), is comprised between 1 and 5, preferably between 1.1 and 4, and more preferably still, between 1.5 and 3.

5. The gas-liquid separation device as claimed in claim 1, in which the length of the liquid return pipe (70) is greater than the distance separating the interfaces (24) and (25) so as to create a “plug” of liquid in said return pipe (70), the purpose of this being to prevent the gas from dropping down toward the liquid zone 39L.

6. The gas-liquid separation device as claimed in claim 1, in which the conical part (47) which connects the upper cap (50) to the lower part (70) of each separation element (27) and (28) makes an angle β with respect to the vertical comprised between 90° and 270°, preferably between 100° and 200°, and for preference, between 120° and 150°.

7. The gas-liquid separation device as claimed in claim 1, in which the density of separation elements (27) and (28) comprised between 5 and 70 units per m² of empty barrel reactor surface area.

8. A process for the three-phase fluidized bed hydroconversion of heavy hydrocarbon fractions using the gas-liquid separation device as claimed in claim 1, in which the operating conditions are as follows:
an absolute pressure comprised between 2 and 35 MPa, preferably between 5 and 25 MPa, and more preferably still, between 6 and 20 MPa, and at
a temperature comprised between 300° C. and 550° C., preferably comprised between 350 and 500° C., and more preferably still, comprised between 370 and 460° C., the favored temperature range lying between 380° C. and 440° C.

9. The process for the three-phase fluidized bed hydroconversion of heavy hydrocarbon fractions using the gas-liquid separation device as claimed in claim 1, in which the surface velocity of the upflow considered inside each inlet pipe (75) is comprised between to 0.1 and 20 m/s, preferably between 0.2 and 15 m/s, and more preferably still, comprised between 0.3 and 10 m/s.
